(19) United States
(12) Patent Application Publication
(10) Pub. No.: US 2026/0035294 A1
(43) Pub. Date: Feb. 5, 2026

(54) Solar Control Coating with Discontinuous Metal Layer

(71) Applicant: Vitro Flat Glass LLC, Cheswick, PA (US)

(72) Inventor: Alexandra Gordienko, Natrona Heights, PA (US)

(21) Appl. No.: 19/283,286

(22) Filed: Jul. 29, 2025

Related U.S. Application Data
(60) Provisional application No. 63/678,283, filed on Aug. 1, 2024.

(51) Int. Cl. C03C 17/23

(52) U.S. Cl. CPC C03C 17/23

(57) ABSTRACT

A solar control coating for a substrate having a discontinuous metal layer, wherein the coating is highly reflective and has an aesthetically desirable blue or silver-blue exterior surface. The coating includes a first dielectric layer, having a tin oxide layer, over the substrate, a first metallic layer over the first dielectric layer, a first primer layer over the first metallic layer, a second dielectric layer over the first primer layer, a second metallic layer over the second dielectric layer, a second primer layer over the second metallic layer, a third dielectric layer over the second primer layer, a third metallic layer over the third dielectric layer, a third primer layer over the third dielectric layer; and a fourth dielectric layer over the third primer layer. At least one of the metallic layers is the subcritical metallic layer and the coating is free from nickel, chromium, and alloys thereof.

### CROSS REFERENCE TO RELATED APPLICATION

This application claims the benefit of U.S. Provisional Application No. 63/678,823, filed Aug. 1, 2024, which is hereby incorporated by reference in its entirety.

### BACKGROUND OF THE INVENTION

### Field of the Invention

This invention relates generally to solar control coatings and, in particular, to a solar control coating having a highly reflective and aesthetically desirable blue or silver-blue exterior surface.

### Description of Related Art

Solar control coatings are known in the field of architectural transparencies. These solar control coatings block or filter selected ranges of electromagnetic radiation, such as in the range of solar infrared or solar ultraviolet radiation, to reduce the amount of solar energy entering the building. The solar heat gain coefficient (SHGC) is the fraction of solar radiation admitted through a window either transmitted directly and/or absorbed and subsequently released as heat inside a building. The lower the SHGC, the less solar heat is transmitted and the greater the shading ability of the window. This reduction of solar energy transmittance helps reduce the load on the cooling units of the building. In some architectural applications, it may be desirable to have a reflective outer surface so as to decrease visibility into the building to retain as much privacy as possible, while still allowing visible light to enter the building and also allowing the workers inside the building to see out. Depending upon the use of the architectural transparency, the reflective surface may be provided on the inner surface of the transparency. Also, these transparencies are typically tempered or heat-treated for increased safety.

In one known architectural transparency, a heat-strengthened glass substrate is coated with a solar control coating having an absorber material. This transparency also includes a relatively thick, continuous, infrared reflective metal layer to reflect solar energy, such as solar infrared energy. However, a problem with this known transparency is that the resulting product appears more yellow-green when compared with other competitor products, resulting in a less desirable exterior aesthetic. Oftentimes, if a flaw occurs or a portion of the glass becomes broken during manufacture, the glass, or cullet i.e. broken glass, can be recycled by melting it down. However, many of the currently produced coatings include a nickel-chromium alloy material (e.g., Inconel®) as one of the layers. Unfortunately, glass products having an Inconel® layer cannot be recycled, resulting in a loss of profitability.

It would be desirable to produce a coating with a specified reflectance (inner and/or outer) and/or transmittance to achieve desirable optical and aesthetic properties. It also would be desirable to make a coated product without an Inconel® or without a nickel-chromium alloy material so that any damaged or broken product (i.e. cullet) be used for recycling purposes.

### SUMMARY OF THE INVENTION

In one aspect of the invention, the coating of the invention includes one or more continuous, infrared reflective metal layers in combination with a separate subcritical (i.e., discontinuous) metal layer. The discontinuous metal layer increases the visible light absorption of the coating and, in combination with dielectric layers of appropriate thickness, can also provide the coated article with asymmetrical reflectance. The particular materials used for the layers and the ratios of the layers used in the coating stack result in an aesthetically desirable blue or silver-blue exterior surface.

A coating of the invention comprises a plurality of metallic layers alternating with a plurality of dielectric layers, with at least one of the metallic layers comprising a subcritical metallic layer having discontinuous metal regions. The first dielectric layer comprises a tin oxide film having a thickness in the range of 90 Å to 220 Å in direct contact with a portion of the substrate.

A coated article comprises a substrate and a coating stack over at least a portion of the substrate. The coating stack comprises a plurality of metallic layers and a plurality of dielectric layers, wherein at least one of the metallic layers comprises a subcritical metallic layer having discontinuous metallic regions.

In accordance with one aspect of the invention, a coated article comprises a substrate and a coating. The coating comprises a first dielectric layer over at least a portion of the substrate; a first metallic layer over the first dielectric layer; a first primer layer over the first metallic layer; a second dielectric layer over the first primer layer; a second metallic layer over the second dielectric layer; a second primer layer over the second metallic layer; a third dielectric layer over the second primer layer; a third metallic layer over the third dielectric layer; a third primer layer over the third dielectric layer; and a fourth dielectric layer over the third primer layer. At least one of the metallic layers is a subcritical metallic layer. The first primer layer, the second primer layer, and the third primer layer are free from nickel, chromium, and alloys thereof, such as an Inconel® alloy. According to one embodiment, the entire coating is free from nickel, chromium, and alloys thereof. A protective coating, such as titania, silica, alumina, zirconia, or mixtures thereof, can be applied over the fourth dielectric layer.

In accordance with another aspect of the invention, a coated article comprising a substrate and a coating. The coating comprises a first dielectric layer over at least a portion of the substrate; a first metallic layer over the first dielectric layer; a first primer layer over the first metallic layer; a second dielectric layer over the first primer layer; a second metallic layer over the second dielectric layer; a second primer layer over the second metallic layer; a third dielectric layer over the second primer layer; a third metallic layer over the third dielectric layer; a third primer layer over the third dielectric layer; and a fourth dielectric layer over the third primer layer, wherein the first dielectric layer comprises a tin oxide film having a thickness in the range of 90 Å to 220 Å in direct contact with a portion of the substrate. According to one embodiment, at least one of the second metallic layer and the third metallic layer is a subcritical metallic layer. The coating is free from nickel, chromium, and alloys thereof. The second dielectric layer can have a thickness in the range of 140 Å to 180 Å. The ratio of the thickness of the first dielectric layer to the thickness of the second dielectric layer can be in the range of 1.2:1 to 1.9:1.

In accordance with another aspect of the invention, a coated article comprising a substrate and a coating. The coating comprises a first dielectric layer over at least a portion of the substrate, wherein the first dielectric layer comprises a tin oxide film; a first metallic layer over the first dielectric layer; a first primer layer over the first metallic layer; a second dielectric layer over the first primer layer; a second metallic layer over the second dielectric layer; a second primer layer over the second metallic layer; a third dielectric layer over the second primer layer; a third metallic layer over the third dielectric layer; a third primer layer over the third dielectric layer; and a fourth dielectric layer over the third primer layer. The at least one of the second and third metallic layers can be a subcritical metallic layer and the coating is free from nickel, chromium, and alloys thereof. A protective coating can be provided over the fourth dielectric layer, wherein the protective coating comprises titania, silica, or mixtures thereof. According to one embodiment, the first dielectric layer can have a thickness in the range of 190 Å to 330 Å, and the second dielectric layer can have a thickness in the range of 140 Å to 180 Å. The ratio of the thickness of the first dielectric layer to the thickness of the second dielectric layer can be in the range of 1.2:1 to 1.9:1.

### BRIEF DESCRIPTION OF THE DRAWINGS

The invention will be described with reference to the following drawing figures, wherein like reference numbers identify like parts throughout.

FIG. 1 is a side view (not to scale) of a coated article including a coating in accordance with an embodiment of the present invention;

FIG. 2 is a side, section view (not to scale) of a subcritical metal layer with a primer layer in accordance with an embodiment of the present invention; and.

FIG. 3 is a side view (not to scale) of an insulating glass unit (IGU) having a coating in accordance with an embodiment of the present invention.

### DESCRIPTION OF THE INVENTION

As used herein, spatial or directional terms, such as “left”, “right”, “inner”, “outer”, “above”, “below”, and the like, relate to the invention as it is shown in the drawing figures. However, it is to be understood that the invention can assume various alternative orientations, and accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate. All documents, such as, but not limited to, issued patents and patent applications, referred to herein are to be considered to be “incorporated by reference” in their entirety. As used herein, the term “film” refers to a coating region of a desired or selected coating composition. A “layer” can comprise one or more “films”, and a “coating” or “coating stack” can comprise one or more “layers”. The term “critical thickness” means a thickness above which a coating material forms a continuous, uninterrupted layer and below which is below the percolation threshold the coating material forms discontinuous regions or islands of the coating material rather than a continuous layer.

For purposes of the following discussion, the invention will be discussed with reference to use with an architectural transparency, such as, but not limited to, a monolithic glass substrate, an insulating glass unit (IGU), and the like. As used herein, the term “architectural transparency” refers to any transparency located on a building, such as, but not limited to, windows and skylights. However, it is to be understood that the invention is not limited to use with such architectural transparencies but could be practiced with transparencies in any desired field, such as, but not limited to, laminated or non-laminated residential and/or commercial windows, insulating glass units, and/or transparencies for land, air, space, above water, and underwater vehicles. Therefore, it is to be understood that the specifically disclosed exemplary embodiments are presented simply to explain the general concepts of the invention, and that the invention is not limited to these specific exemplary embodiments. Additionally, while a typical “transparency” can have sufficient visible light transmission such that materials can be viewed through the transparency, in the practice of the invention, the “transparency” need not be transparent to visible light but may be translucent or opaque.

The discussion of the invention may describe certain features as being “particularly” or “preferably” within certain limitations (e.g., “preferably”, “more preferably”, or “most preferably”, within certain limitations). It is to be understood that the invention is not limited to these particular or preferred limitations but encompasses the entire scope of the disclosure.

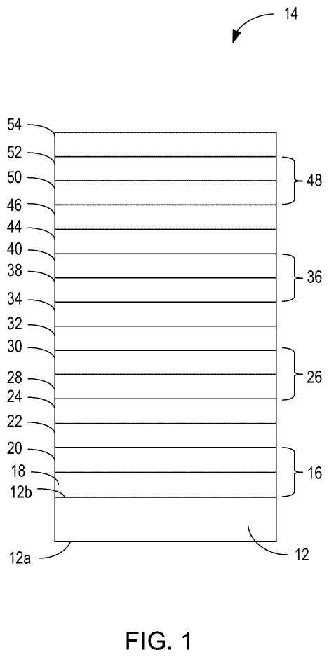

Reference is now made to FIG. 1, which shows a coated article, generally designed as 10 including an exemplary non-limiting solar control coating in accordance with the invention. The coated article 10 comprises a substrate 12 and the solar control coating 14. The substrate has a first surface or No. 1 surface 12a and a second surface or No. 2 surface 12b. The substrate 12 can be a transparency having any desired visible light, infrared radiation, or ultraviolet radiation transmission and/or reflectance. The transparency may be translucent or opaque and/or can have a visible light transmission of any desired amount, e.g., greater than 0% up to 100%.

Examples of suitable materials include but are not limited to, plastic substrates (such as acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyl-eneterephthalates, polybutyleneterephthalates, and the like; polysiloxane-containing polymers; or copolymers of any monomers for preparing these, or any mixtures thereof); ceramic substrates; glass substrates; or mixtures or combinations of any of the above. For example, the substrate 12 can include conventional soda-lime-silicate glass, borosilicate glass, or leaded glass and can be made by a float glass process. Examples of float glass processes are disclosed in U.S. Pat. Nos. 4,466,562 and 4,671,155.

The solar control coating 14 is deposited over at least a portion of at least one major surface, such as 12b, of the substrate 12. As used herein, the term “solar control coating” refers to a coating comprised of one or more layers or films that affect the solar properties of the coated article, such as, but not limited to, the amount of solar radiation, for example, visible, infrared, or ultraviolet radiation, reflected from, absorbed by, or passing through the coated article; shading coefficient; emissivity, etc. The solar control coating 14 can block, absorb, or filter selected portions of the solar spectrum, such as, but not limited to the IR, UV, and/or visible spectrums.

The solar control coating 14 can be deposited by any conventional method, such as, but not limited to, conventional chemical vapor deposition (CVD) and/or physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as, but not limited to, sol-gel deposition. In one non-limiting embodiment, the coating 30 can be deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328, 768; and 5,492,750.

The solar control coating 14 comprises a first dielectric layer 16 located over at least a portion of the substrate 12. A first metallic layer 22 is located over the first dielectric layer 16. A first primer layer 24 is located over the first metallic layer 22. A second dielectric layer 26 is located over the first primer layer 24. A second metallic layer 32 is located over the second dielectric layer 26. A second primer layer 34 is located over the second metallic layer 32. A third dielectric layer 36 is located over the second primer layer 34. A third metallic layer 44 is located over the third dielectric layer 36. A third primer layer 46 is located over the third dielectric layer 36. A fourth dielectric layer 48 is located over the third primer layer 46.

Examples for the primer layers 24, 34, 46 include, but are not limited to titanium, silicon, silicon dioxide, silicon nitride, silicon oxynitride, zirconium, aluminum, alloys of aluminum and zinc, alloys of silicon and aluminum, alloys containing cobalt, and mixtures thereof. For example, the primer layers 24, 34, 46 can be a titanium with the first and second primer layers 24 and 34 having a thickness in the range of 10 Å to 60 Å, such as 20 Å to 50 Å, such as 25 Å to 40 Å and the third primer layer 46 having a thickness in the range of 10 Å to 60 Å, such as 20 Å to 55 Å, such as 25 Å to 55 Å. The primer layers are deposited as metals and at least partially oxidize to form an oxide or a sub-oxide during the deposition of the next layer. For example, if titanium is deposited, upon the deposition of the next dielectric layer, the titanium will partially oxidize to form TiOₓ wherein x is less than 2 or will form TiO₂. The purpose of the primer layer is to protect the metallic layer 22, 32, 46 from oxidizing during the deposition of a dielectric 16, 26, 36 above the primer layer 24, 34, 46 and metallic layer 22, 32, 44.

The metallic layers 22, 32, 44 can be formed from a reflective metal. Examples of a reflective metal include, but are not limited to, metallic gold, copper, palladium, aluminum, silver, or mixtures, alloys, or combinations thereof. In one embodiment, at least one of the metallic layers comprises a metallic silver layer which is a continuous layer. By “continuous layer” is meant that the coating forms a continuous film of the material and not isolated coating regions.

At least one of the metallic layers 22, 32, 44 is a subcritical (discontinuous) metallic layer. The subcritical metallic layer can have a theoretical thickness of between 0.7-1.4 nm, between 0.8-1.0 nm, or between 0.84-0.96 nm. Theoretical thickness means the thickness one would assume that the layer has if it were to be a continuous layer based on calculations from the amount of power and time to sputter the layer. According to one embodiment, the second metallic layer 32 is a subcritical metallic layer. The subcritical metallic layer 32, can be metallic gold, copper, palladium, aluminum, silver, or mixtures, alloys, or combinations thereof, that is applied at a subcritical thickness.

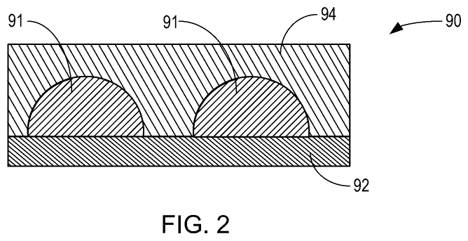

Reference is made to FIG. 2 which shows a side view of a subcritical metallic layer, generally indicated as 90 having discontinuous coating regions 91 formed on a dielectric layer 92 and covered by a primer layer 94. It can be appreciated that this subcritical metallic layer/primer layer 90 may be used as at least one of the metallic/primer/dielectric layer combination as discussed above. The subcritical metal thickness is below the metal's percolation threshold. When the primer layer 94 is applied over the subcritical metal layer, the material of the primer layer covers the subcritical metal and can also extend into the gaps between the subcritical metal and contact the underlying dielectric layer 92.

Referring back to FIG. 1, the first primer layer 24, the second primer layer 34, and/or the third primer layer 46 are free from nickel, chromium, and alloys thereof, such as an Inconel® alloy. According to one embodiment, the entire coating 14 is free from nickel, chromium, and alloys thereof. The elimination of these materials from the coating results in a final product having an aesthetically desirable blue or silver-blue exterior surface when compared to prior products and eliminates the need to separate the cullet during manufacturing.

A protective coating or overcoat 54, can be applied over the fourth dielectric layer 48 to protect the underlying coating layers from mechanical and chemical attack. This protective overcoat 54 can be formed from titania, silica, or mixtures thereof.

The first dielectric layer 16 can comprise a multi-film structure having a first film 18, e.g., a metal oxide film deposited over at least a portion of a substrate, such as the inner major surface 12b of the substrate 12 and a second film 20, e.g. a metal oxide or oxide mixture film, deposited over the first metal alloy oxide film 18. According to one embodiment, this first film 18 can comprise tin oxide which is applied in direct contact with a portion of the substrate 12. The tin oxide can have a thickness in the range of 90 Å to 220 Å, such as, such as 95 Å to 210 Å, such as 100 Å to 200 Å. The second film 20 can be a metal oxide film, such as zinc oxide (for example, 90 wt. % zinc oxide and 10 wt. % tin oxide).

According to one embodiment, the ratio of the thickness of the first dielectric layer 16 to the thickness of the second dielectric layer 26 can be in the range of 1.2:1 to 1.9:1, such as 1.2:1 to 1.8:1, such as 1.3:1 to 1.8:1.

According to one example, the first dielectric layer 16 can have a thickness in the range of 190 Å to 330 Å, such as 200 Å to 320 Å, such as 205 Å to 310 Å. The second dielectric layer 26 can have a thickness in the range of 140 Å to 190 Å, such as 150 Å to 190 Å, such as 155 Å to 185 Å.

According to one embodiment, the second dielectric layer 26 can comprise a first film 28 and a second film 30, wherein the second film 30 comprises a zinc-tin alloy having a thickness of 70 Å to 130 Å, such as 70 Å to 115 Å, such as 85 Å to 115 Å. An optional third metal oxide film, such as another zinc oxide layer (not shown), can be deposited over the second film 30. The second metallic layer 32 can be the subcritical metallic layer. The thickness of the subcritical metallic layer can be approximately 1.2-1.4 nm. The second primer layer 34 is free from nickel, chromium, and alloys thereof and/or free from Inconel®. As discussed above, providing a coating 14 that is free from nickel, chromium, and alloys thereof, such as Inconel®, results in a manufacturing process, wherein the cullet can be recycled, as needed. The coating profile of the invention also results in a product that has an aesthetically desirable blue or silver-blue exterior surface.

The third dielectric layer 36 can comprise a first film 38 and a second film 40. According to one embodiment, the first film 38 of the third dielectric layer 36 can be a zinc-tin alloy and the second film 40 of the third dielectric layer 36 can be zinc oxide (for example, 90 wt. % zinc oxide and 10 wt. % tin oxide).

The fourth dielectric layer 48 can comprise a first film 50 and a second film 52. According to one embodiment, the first film 50 of the fourth dielectric layer 48 can be zinc oxide (for example, 90 wt. % zinc oxide and 10 wt. % tin oxide), and the second film 52 of the fourth dielectric layer 48 can be zinc-tin alloy.

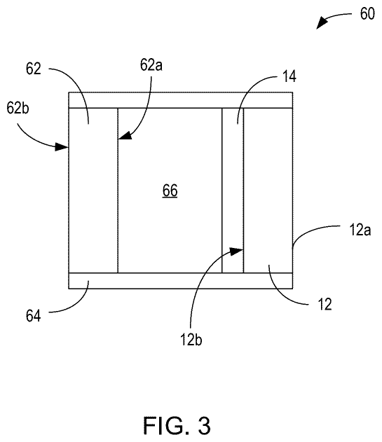

Reference is now made to FIG. 3, which shows an exemplary insulating glass unit (IGU), generally indicated as 60. The insulating glass unit 10 comprises the substrate 12, or a “first substrate”, having the No. 1 surface 12a and the opposed No. 2 surface 12b. The insulated glass unit 60 also includes a second substrate 62 having a No. 3 surface 62a and an opposed No. 4 surface 62b. The first and second substrates 12, 62 can be connected together in any suitable manner, such as by being adhesively bonded to a conventional spacer frame 64. A gap or chamber 66 is formed between the two substrates 12, 62. The chamber 66 can be filled with a selected atmosphere, such as air, or a non-reactive gas such as argon or krypton gas. The solar control coating 14 of the invention is formed over at least a portion of one of the plies 12, 62, such as, but not limited to, over at least a portion of the No. 2 surface 12b or at least a portion of the No. 3 surface 62b. Although, the coating could also be on the No. 1 surface 12a or the No. 4 surface 62b if desired. A “standard IGU” has an outer ply of 6 mm thick glass, an inner ply of 6 mm glass, a 0.5 inch (1.27 cm) gap filled with air or a non-reactive gas, with the coating on the No. 2 surface, however, it is recognized that the first and second substrates 12, 62 can be of any desired dimensions, e.g., length, width, shape, or thickness and that any known glass can be used to form the substrates 12, 62. The glass used in the IGU may be any glass known in the art. Examples of insulating glass units are found, for example, in U.S. Pat. Nos. 4,193,236; 4,464,874; 5,088,258; and 5,106,663.

The following numbered clauses are illustrative of various aspects of the disclosure:

Clause 1: A coated article comprising: a substrate; and a coating comprising: a first dielectric layer over at least a portion of the substrate; a first metallic layer over the first dielectric layer; a first primer layer over the first metallic layer; a second dielectric layer over the first primer layer; a second metallic layer over the second dielectric layer; a second primer layer over the second metallic layer; a third dielectric layer over the second primer layer; a third metallic layer over the third dielectric layer; a third primer layer over the third dielectric layer; and a fourth dielectric layer over the third primer layer; wherein, at least one of the first metallic layer, the second metallic layer and the third metallic layer is a subcritical metallic layer, and wherein, the first primer layer, the second primer layer, and the third primer layer are free from nickel, chromium, and alloys thereof.

Clause 2: The coated article of clause 1, comprising a protective coating over the fourth dielectric layer.

Clause 3: The coated article of clause 2, wherein the protective coating comprises titania, silica, or mixtures thereof.

Clause 4: The coated article of any of clauses 1-3, wherein the first dielectric layer comprises a first film and a second film, wherein the first film comprises tin oxide in direct contact with a portion of the substrate.

Clause 5: The coated article of clause 4, wherein the tin oxide has a thickness in the range of 90 Å to 220 Å, such as such as 95 Å to 210 Å.

Clause 6: The coated article of any of clauses 1-5, wherein the ratio of the thickness of the first dielectric layer to the thickness of the second dielectric layer is in the range of 1.2:1 to 1.9:1, such as 1.2:1 to 1.8:1.

Clause 7: The coated article of any of clauses 1-6, wherein the first dielectric layer has a thickness in the range of 190 Å to 330 Å, such as 200 Å to 320 Å.

Clause 8: The coated article of any of clauses 1-7, wherein the second dielectric layer has a thickness in the range of 140 Å to 190 Å, such as 150 Å to 190 Å.

Clause 9: The coated article of any of clauses 1-8, wherein the second dielectric layer comprises a first film and a second film, wherein the second film comprises a zinc-tin alloy having a thickness of 70 Å to 130 Å, such as 70 Å to 115 Å.

Clause 10: The coated article of any of clauses 1-9, wherein the second metallic layer is the subcritical metallic layer and the second primer layer is free from nickel, chromium, and alloys thereof.

Clause 11: The coated article of any of clauses 1-10, wherein the coating is free from an Inconel® alloy (nickel-chromium alloy).

Clause 12: A coated article comprising: a substrate; and a coating comprising: a first dielectric layer over at least a portion of the substrate; a first metallic layer over the first dielectric layer; a first primer layer over the first metallic layer; a second dielectric layer over the first primer layer; a second metallic layer over the second dielectric layer; a second primer layer over the second metallic layer; a third dielectric layer over the second primer layer; a third metallic layer over the third dielectric layer; a third primer layer over the third dielectric layer; and a fourth dielectric layer over the third primer layer; wherein the first dielectric layer comprises a tin oxide film having a thickness in the range of 90 Å to 220 Å, such as 95 Å to 210 Å, in direct contact with a portion of the substrate.

Clause 13: The coated article of clause 12, wherein, at least one of the second metallic layer and the third metallic layer is a subcritical metallic layer.

Clause 14: The coated article of clause 12 or clause 13, wherein the coating is free from nickel, chromium, and alloys thereof.

Clause 15: The coated article of any of clauses 12-14, wherein the second dielectric layer has a thickness in the range of 140 Å to 190 Å, such as 150 Å to 190 Å.

Clause 16: The coated article of any of clauses 12-15, wherein the ratio of the thickness of the first dielectric layer to the thickness of the second dielectric layer is in the range of 1.2:1 to 1.9:1, such as 1.2:1 to 1.8:1.

Clause 17: A coated article comprising: a substrate; and a coating comprising: a first dielectric layer over at least a portion of the substrate, wherein the first dielectric layer comprises a tin oxide film; a first metallic layer over the first dielectric layer; a first primer layer over the first metallic layer; a second dielectric layer over the first primer layer; a second metallic layer over the second dielectric layer; a second primer layer over the second metallic layer; a third dielectric layer over the second primer layer; a third metallic layer over the third dielectric layer; a third primer layer over the third dielectric layer; and a fourth dielectric layer over the third primer layer; wherein, at least one of the second metallic layer and the third metallic layer is a subcritical metallic layer, and wherein, the coating is free from nickel, chromium, and alloys thereof.

Clause 18: The coated article of clause 17, comprising a protective coating over the fourth dielectric layer, wherein the protective coating comprises titania, silica, or mixtures thereof.

Clause 19: The coated article of clause 17 or clause 18, wherein the first dielectric layer has a thickness in the range of 190 Å to 330 Å, such as 200 Å to 320 Å, and the second dielectric layer has a thickness in the range of 140 Å to 190 Å, such as 150 Å to 190 Å.

Clause 20: The coated article of any of clauses 17-19, wherein the ratio of the thickness of the first dielectric layer to the thickness of the second dielectric layer is in the range of 1.2:1 to 1.9:1, such as 1.2:1 to 1.8:1.

The following examples illustrate various embodiments of the invention. However, it is to be understood that the invention is not limited to these specific embodiments.

### Example 1

A coating was deposited by a conventional MSVD coater on a 6 mm piece of clear glass. The coated glass had the following structure:

| back Clear | 5.0 | |
|---|---|---|
| Clear | 59900000.0 | |
| SnO2- | 106.0 | Å |
| Zn90 | 111.0 | Å |
| Ag | 199.4 | Å |
| TiOx | 32.3 | Å |
| Zn90 | 69.4 | Å |
| ZnSn | 111.5 | Å |
| Subcritical Ag | 1.2-1.4 | nm |
| ZnSn | 513 | Å |
| Zn90 | 76.8 | Å |
| Ag | 171.7 | Å |
| TiOx | 39.0 | Å |
| Zn90 | 72.0 | Å |
| ZnSn | 179.0 | Å |
| TiOx | 59.0 | Å |

| | |
|---|---|
| Air | 1000000.0 |
| Clear | 57000000.0 |
| Air | 1000000.0 |

The coated glass was heat treated. Note that the second primer layer is not specified as a separate layer in Example 1, however, the second primer layer is located adjacent to the sub-critical Ag layer and the optical properties of the second primer layer are combined with the optical properties of the sub-critical Ag layer. The coated article can be used as a monolithic glass layer or incorporated into a standard IGU as the outer ply.

### Example 2

A coating was deposited by a conventional MSVD coater on a 6 mm piece of clear glass. The coated glass had the following structure:

| back Clear | 5.0 | |
|---|---|---|
| Clear | 60000000.0 | |
| Clear-ZnSn | 44.3 | Å |
| SnO2 | 197.3 | Å |
| Zn90 | 109.5 | Å |
| Ag | 195.2 | Å |
| TiOx | 34.9 | Å |
| Zn90 | 70.4 | Å |
| ZnSn | 100.9 | Å |
| Subcritical Ag | 1.2-1.4 | nm |
| ZnSn | 536.0 | Å |
| Zn90 | 120.3 | Å |
| Ag | 154.2 | Å |
| TiOx | 33.2 | Å |
| Zn90 | 81.0 | Å |
| ZnSn | 209.8 | Å |
| TiOx | 42.9 | Å |

| | |
|---|---|
| Air | 10000000.0 |
| Clear | 60000000.0 |
| Air | 10000000.0 |

The coated glass was heat treated. As in Example 1, the second primer layer is not specified in Example 2 but is located adjacent to the sub-critical Ag layer and the optical properties of this layer are combined with the optical properties of the sub-critical Ag layer. The coated article can be used as a monolithic glass layer or can be incorporated into a standard IGU as the outer ply.

### Example 3

A coating was deposited by a conventional MSVD coater on a 6 mm piece of clear glass. The coated glass had the following structure:

| back Clear | 5.0 | |
|---|---|---|
| Clear | 60000000.0 | |
| Clear-ZnSn heated | 44.3 | |
| SnO2-a heated | 100.0 | |
| Zn90 heated | 109.5 | |
| Ag heated | 178.7 | |
| TiOx | 34.9 | Å |
| Zn90 | 70.4 | Å |
| ZnSn | 87.5 | Å |
| Subcritical Ag | 1.2-1.4 | nm |
| ZnSn | 523.9 | Å |
| Zn90 | 120.3 | Å |
| Ag | 152.6 | Å |
| TiOx | 33.2 | Å |
| Zn90 | 81.0 | Å |
| ZnSn | 211.3 | Å |
| TiOx | 42.8 | Å |

| | |
|---|---|
| Air | 10000000.0 |
| Clear | 60000000.0 |
| Air | 10000000.0 |

The coated glass was heat treated. The second primer layer is not specified as a separate layer in Example 3, however, the second primer layer is located adjacent to the sub-critical Ag layer and the optical properties of the second primer layer are combined with the optical properties of the sub-critical Ag layer. The coated article can be used as a monolithic glass article or can be incorporated into a standard IGU as the outer ply.

It will be readily appreciated by those skilled in the art that modifications may be made to the invention without departing from the concepts disclosed in the foregoing description. Accordingly, the particular embodiments described in detail hereinabove are illustrative only and are not limited as to the scope of the invention, which is to be given the full breadth of the appended claims and any and all equivalents thereof.

What is claimed is:

1. A coated article comprising:
a substrate; and
a coating comprising:
a first dielectric layer over at least a portion of the substrate;
a first metallic layer over the first dielectric layer;
a first primer layer over the first metallic layer;
a second dielectric layer over the first primer layer;
a second metallic layer over the second dielectric layer;
a second primer layer over the second metallic layer;
a third dielectric layer over the second primer layer;
a third metallic layer over the third dielectric layer;
a third primer layer over the third dielectric layer; and
a fourth dielectric layer over the third primer layer;
wherein, at least one of the first metallic layers, the second metallic layer and the third metallic layer is a subcritical metallic layer, and wherein, the first primer layer, the second primer layer, and the third primer layer are free from nickel, chromium, and alloys thereof.

2. The coated article of claim 1, comprising a protective coating over the fourth dielectric layer.

3. The coated article of claim 2, wherein the protective coating comprises titania, silica, or mixtures thereof.

4. The coated article of claim 1, wherein the first dielectric layer comprises a first film and a second film, wherein the first film comprises tin oxide in direct contact with a portion of the substrate.

5. The coated article of claim 4, wherein the tin oxide has a thickness in the range of 90 Å to 220 Å.

6. The coated article of claim 1, wherein the ratio of the thickness of the first dielectric layer to the thickness of the second dielectric layer is in the range of 1.2:1 to 1.9:1.

7. The coated article of claim 1, wherein the first dielectric layer has a thickness in the range of 190 Å to 330 Å.

8. The coated article of claim 1, wherein the second dielectric layer has a thickness in the range of 140 Å to 190 Å.

9. The coated article of claim 1, wherein the second dielectric layer comprises a first film and a second film, wherein the second film comprises a zinc-tin alloy having a thickness of 70 Å to 130 Å.

10. The coated article of claim 1, wherein the second metallic layer is the subcritical metallic layer, and the second primer layer is free from nickel, chromium, and alloys thereof.

11. The coated article of claim 1, wherein the coating is free from an Inconel® alloy (nickel-chromium alloy).

12. A coated article comprising:
a substrate; and
a coating comprising:
a first dielectric layer over at least a portion of the substrate;
a first metallic layer over the first dielectric layer;
a first primer layer over the first metallic layer;
a second dielectric layer over the first primer layer;
a second metallic layer over the second dielectric layer;
a second primer layer over the second metallic layer;
a third dielectric layer over the second primer layer;
a third metallic layer over the third dielectric layer;
a third primer layer over the third dielectric layer; and
a fourth dielectric layer over the third primer layer;
wherein the first dielectric layer comprises a tin oxide film having a thickness in the range of 90 Å to 220 Å in direct contact with a portion of the substrate.

13. The coated article of claim 12, wherein, at least one of the second metallic layer and the third metallic layer is a subcritical metallic layer.

14. The coated article of claim 12, wherein the coating is free from nickel, chromium, and alloys thereof.

15. The coated article of claim 12, wherein the second dielectric layer has a thickness in the range of 140 Å to 190 Å.

16. The coated article of claim 12, wherein the ratio of the thickness of the first dielectric layer to the thickness of the second dielectric layer is in the range of 1.2:1 to 1.9:1.

17. A coated article comprising:
a substrate; and
a coating comprising:
a first dielectric layer over at least a portion of the substrate, wherein the first dielectric layer comprises a tin oxide film;
a first metallic layer over the first dielectric layer;
a first primer layer over the first metallic layer;
a second dielectric layer over the first primer layer;
a second metallic layer over the second dielectric layer;
a second primer layer over the second metallic layer;
a third dielectric layer over the second primer layer;
a third metallic layer over the third dielectric layer;
a third primer layer over the third dielectric layer; and
a fourth dielectric layer over the third primer layer;
wherein, at least one of the second metallic layer and the third metallic layer is a subcritical metallic layer, and wherein, the coating is free from nickel, chromium, and alloys thereof.

18. The coated article of claim 17, comprising a protective coating over the fourth dielectric layer, wherein the protective coating comprises titania, silica, or mixtures thereof.

19. The coated article of claim 17, wherein the first dielectric layer has a thickness in the range of 190 Å to 330 Å and the second dielectric layer has a thickness in the range of 140 Å to 190 Å.

20. The coated article of claim 17, wherein the ratio of the thickness of the first dielectric layer to the thickness of the second dielectric layer is in the range of 1.2:1 to 1.9:1.
